(19) United States
(12) Patent Application Publication
(10) Pub. No.: US 2026/0004504 A1
(43) Pub. Date: Jan. 1, 2026

(54) APPLYING TEXTURES TO 3D MODELS THROUGH USE OF A PROXY MESH

(71) Applicant: Adobe Inc., San Jose, CA (US)

(72) Inventors: Robin Faury, Clermont-Ferrand (FR); Jeremy Levallois, Lyon (FR); Jean Thiery, Paris (FR); Alexandre Lanvin, Biot (FR)

(21) Appl. No.: 18/755,285

(22) Filed: Jun. 26, 2024

(51) Int. Cl. G06T 15/04; G06T 17/20

(52) U.S. Cl. CPC G06T 15/04; G06T 17/205

(57) ABSTRACT

A decal application program applies textures to three-dimensional models through use of a proxy mesh. The decal application program accesses the three-dimensional model source material data which describes surface appearances values associated with the three-dimensional model. The decal application program also accesses decal source material data which describes one or more surface appearance values associated with a decal object. The decal application program generates a proxy mesh for a portion of a surface of the three-dimensional model data, with proxy mesh geometric data representing a portion of the surface of the three-dimensional model. The decal application program deforms the proxy mesh to minimize distance values between the proxy mesh geometric data and a portion of three-dimensional model source material data that represents the portion of the surface of the three-dimensional model. The decal application program then applies the decal data onto the deformed proxy mesh.

### TECHNICAL FIELD

This disclosure generally relates to computer graphics and, more specifically, to applying textures to 3D models through use of a proxy mesh.

### BACKGROUND

In graphics applications, objects are often represented by three-dimensional (3D) models, which can include a variety of orientations including meshes, point clouds, neural networks, and implicit surfaces. A graphics application can then manipulate the 3D model to provide a desired depiction of a corresponding object. For instance, the graphics application can modify the shape of the 3D model or change its surface appearance. The resulting 3D model can be used in various contexts, such as in engineering modeling or real-time video gaming.

Three-dimensional modeling often involves applying a material, sometimes including a 2D or 3D decal image or object, onto a 3D model representing an object to overlay the decal image or object onto the 3D model.

### SUMMARY

In some embodiments, a computing system implementing a decal application program described herein accesses three dimensional model source material data and decal source material data. The three dimensional source material data and decal source material data can include data that describes one or more surface appearance values of a three dimensional model and of a decal object respectively.

The computing system generates a proxy mesh that maps to a portion of the surface of the three dimensional model source material data. The proxy mesh geometric data will then represent the portion of the surface of the 3D model. The proxy mesh begins as a UV parameterized grid that can map and deform to fit a portion of the surface of the three dimensional model source material data. Deformation may be done by minimizing one or more distance values between the proxy mesh geometric data and a portion of the 3D model source material data. The computing system applies the decal data to the deformed proxy mesh. As a result, a decal object can be applied to an underlying three dimensional model and include geometric characteristics of the underlying three dimensional model through use of the proxy mesh.

Deforming the proxy mesh may be performed by a variety of error minimization techniques such as quadric error functional minimization. The proxy mesh begins as a UV parameterized grid, and error minimization techniques are then applied to deform the proxy mesh and minimize the UV distortion. The deformed proxy mesh includes its own geometric data that can be further approximated during the deformation process to minimize the number of vertices data.

### BRIEF DESCRIPTION OF THE DRAWINGS

Features, embodiments, and advantages of the present disclosure are better understood when the following Detailed Description is read with reference to the accompanying drawings.

FIG. 1 shows an example of a computing system including a rendering engine interacting with a Gbuffer to generate a proxy mesh according to certain embodiments of this disclosure.

FIG. 2 shows an example of a computing system including a Gbuffer interacting with a decal application program to generate a proxy mesh according to certain embodiments of this disclosure.

FIG. 3 shows an example of a process for applying decal source material onto a deformed proxy mesh according to certain embodiments of this disclosure.

FIG. 4 shows an example of a generated proxy mesh according to certain embodiments of this disclosure.

FIGS. 5A-C show a proxy mesh deformation process according to certain embodiments of this disclosure.

FIG. 6 shows an example of geometric data a proxy mesh according to certain embodiments of this disclosure

FIG. 7 shows an example of a computing system configured for applying textures to 3D models through use of a proxy mesh according to certain embodiments of this disclosure.

### DETAILED DESCRIPTION

The present disclosure includes systems and methods for applying a decal object onto a three-dimensional (3D) model by aid of a proxy mesh, wherein the proxy mesh corresponds to a portion of the underlying 3D model and is deformed to model the surface of the 3D model. Decal object data is applied onto the proxy mesh so that the decal object can be modeled to fit the corresponding surface of the underlying 3D model.

Conventionally, the application of a decal onto a 3D model can be cumbersome due to different surface representations of the 3D model. For instance, for point cloud representations, the visual quality of an overlayed decal object will depend on the number and accuracy of the sampled points when using conventional techniques. Implicit surfaces are similarly difficult to overlay due to lack of easy parameterization. Different object representations, such as point clouds representations, voxel representations, and implicit surface representations typically require different methods for applying decals. The lack of a uniform method for applying decal objects to 3D models requires increased memory storage and resource allocation for various functions capable applying decals to the corresponding surface representations. Additionally, current methods for applying decals to corresponding surface representations may be inefficient. Because there is no generic method for applying decal objects to 3D models, applying decals to different surface object representations may produce different artifacts and inconsistencies depending on the method used, as method itself depends on the underlying object representation. One current approach to resolving issues related to different surface representations is to provide global UV parameterization, when possible, to objects and decals in a graphical environment. However, this approach is similarly computing intensive and requires significant resource allocation, including allocation of computer processors to the specialized tasks of computing and rendering graphics for the 3D model, the decal object, and the peripheral graphic environment.

Certain embodiments described herein facilitate graphical modeling by generalizing the surface representation of the underlying 3D model when overlaying textures, such as a decal object, or image on the underlying 3D model regardless of the underlying surface representation of the 3D model. The invention relates to applying textures to the 3D model, such textures can include, but are not limited to, 2D or 3D decal objects. The following non-limiting example is provided to introduce certain embodiments. In this example, a decal application program described herein can process a 3D rendering of a 3D model, and a decal object, and apply the decal object to the 3D model while maintaining geometries and textures of both the model and the object.

In this example, a computing system implementing the decal application program accesses 3D model source material data. The 3D model source material data includes data that describes one or more surface appearance values associated with a 3D model. The surface appearance values may comprise material map data such as material maps or spatially-varying bidirectional reflectance distribution functions (SVBRDF maps) that include a set of 2D textures such as base color, displacement, roughness, or metalness, encoding the physical properties of the material apply on the 3D model. The surface appearance values may also comprise geometric map data including vertices, surface normals, curvature data, and other geometric data.

In this example, the computing system accesses decal source material data which includes data that describes one or more surface appearance values associated with a decal object. The decal source material data includes data similar to the 3D model source material data. The decal object may be a 2D or 3D model.

In this example, the decal application program generates a proxy mesh for a portion of a surface of the 3D model source material data. The generated proxy mesh comprises proxy mesh, geometric map data, aka geometric data representing the portion of the surface of the 3D model. The proxy mesh has a UV parameterized grid that is initiated in a planar configuration comprising one or more subgrids.

In this example, the decal application program deforms the proxy mesh to minimize one or more distance values between the proxy mesh geometric map data, aka geometric data and a portion of the 3D model source material data that represents the portion of the surface of the 3D model. The geometric data of the proxy mesh can include vertices, planes, edges, Bezier curves and Bezier control points, or other data defining positions and surfaces of the proxy mesh.

In this example, the decal application program applies decal source material data onto the deformed proxy mesh. The proxy mesh maintains a UV parameterization that minimizes deformations during the deformation process, and so applying decal source material data onto the deformed proxy mesh can include UV mapping and UV unwrapping.

Certain embodiments described herein facilitate graphical modeling by allowing the overlay of a decal object on an underlying 3D model regardless of the underlying surface representation of the 3D model. Because underlying 3D models may comprise various surface representation including meshes, point clouds, and implicit surfaces, it can be difficult to uniformly overlay the decal image or object on the underlying 3D model surface. Embodiments herein described thus provide an improvement in the technical filed of computer graphics by providing for generation of proxy meshes which can be applied to 3D model surfaces regardless of underlying surface representations and for application of the decal image or object onto such proxy meshes.

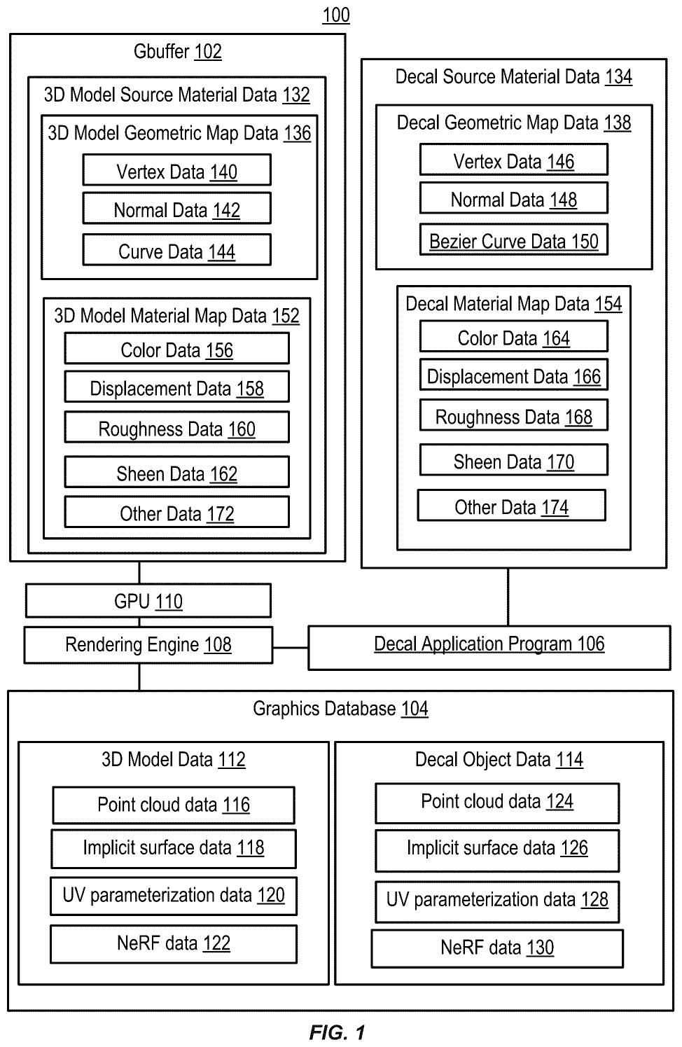

Referring now to the drawings, FIG. 1 shows an example of a computing system 100 with a decal application program 106 interfacing with a Gbuffer 102. The computing system also includes a graphics database 104 storing a variety of graphics data 132-174, a rendering engine 108 and graphics processing unit 110 (“GPU”) communicatively coupled to the graphics database 104 and the decal application program 106. The embodiment depicted in FIG. 1 is merely an example and is not intended to limit the scope of the described embodiments. Many possible variations, alternatives, and modifications are within the scope of this disclosure. For example, in some implementations, more or fewer systems or components than those shown in FIG. 1 may be provided, two or more systems or components may be combined, or a different configuration or arrangement of systems and components may be provided.

The computing system 100 is implemented as hardware, software (e.g., software modules and/or firmware), or a combination of hardware and software. For instance, decal application program 106 and/or the rendering engine 108 executed by the computing system 100 may be integrated or interoperable with an application, such as a computer-aided design (CAD) application, a drawing application, or some other application in which graphical 3D models can be manipulated. Computing system 100 may comprise multiple computing systems operating in conjunction with each other.

The computing system 100 can be of various types, such as a server, a desktop computer, a notebook computer, a tablet, or a smartphone. Examples of the decal application program 106 and the rendering engine 108 are implemented as program code stored in a non-transitory computer-readable medium or as a specialized hardware device such as a field-programmable gate array. Additionally, or alternatively, examples of the decal application program 106 and the rendering engine 108 run on a distributed system of computing devices. For example, the decal application program 106 and/or rendering engine 108 may be implemented by one or more computing systems of a cloud service provider infrastructure. Alternatively, the decal application program 106 may be implemented on one or more computing systems and the rendering engine 108 may be implemented on one or more different computing systems. Other software architectures are possible and will be apparent to those skilled in the art.

As shown in FIG. 1, a graphics database 104 is shown communicatively coupled with a Gbuffer data 102 through a rendering engine 108 and GPU 110. The rendering engine 108, as a software or firmware, may include instructions to retrieve data 112-130 from the graphics database 104 for storage in the Gbuffer data 102. The instructions stored on the rendering engine 108 may be executed by the GPU 110.

The graphics database 104 includes 3D model data 112 and decal object data 114. This data 112 114 also referred to as representation data, represents the data of an underlying 3D model and decal model respectively. Object data 112 114 includes point cloud data 116 124, implicit surface data 118 126, UV parameterization data 120 128, and/or neural radiance field (“NeRF”) data 122, 130. Additional data may be stored in the graphics database 104 as object data 112 114. For instance, voxel data, and other data for providing a 2D or 3D representation of an object such as a 3D model or decal model may be stored in the graphics database 104. The graphics database 104 may provide for non-transient storage of underlying data structures 112-130. The graphics database 104 may not store every form of data 116-130, and instead is shown as capable of storing such data. For instance, the computing system 100 may store 3D model data 112 in the form of point cloud data 116, while not retaining implicit surface data or NeRF data 122 of the 3D model. The 3D model may represent a target object for which the decal model may be applied to.

Data from the graphics database 104 may be processed by the rendering engine 108 and GPU 110 as represented by the Gbuffer data 102. The rendering engine 108 processes data from the graphics database 104 from the perspective of a display viewpoint (“camera”) to provide a specific point of view representation of the 3D model. The specific point of view representation of the 3D model data 112 is referred to as the 3D model source material data 132. 3D model source material data is reprocessed by the rendering engine 108 at each frame when a camera moves. The specific processing of the data by the rendering engine 108 may be referred to as the deferred rendering, wherein only geometric data is calculated. Subsequent renderings performed by the rendering engine 108, such as lighting and shading renderings are not yet processed, nor stored, as Gbuffer data 102. Thus, the Gbuffer data 102 is partially rendered data processed by the rendering engine 108, providing a specific point of view representation of the data stored in the graphics database 104.

Gbuffer data 102 includes map data including 3D model geometric map data 136 and 3D model material map data 152 describing the 3D scene. A map is an image that can be described as a 2D array of pixels used to store geometric and material data. To render a 3D model on screen, every 3D object property is projected onto an intermediate collection of images at the same resolution of screen, as referred to as Gbuffer data 102. For example, the 3D model geometric map data includes 3D positions, orientations, and curvatures as geometric quantities visible from the camera according to vertex data 140, normal data 142, and curve data 144. Most GPUs in computing devices will export Gbuffer data 102 in the form of at least the 3D model geometric map data 136, including the vertex data 140, normal data 142, and curve data 144. Additionally, the decal application program 106 can access other Gbuffer data 102 including color data 156, displacement data 158, roughness data 160, sheen data 162, and any other material map data 172 including metalness, additional, normals, clear coat shading, or glints. Other 3D model data stored in the Gbuffer may include specular maps, or any other intermediate rendering generated each frame by the GPU 110. Traditionally, the Gbuffer data 102 is used by in a complete rendering process, to be further rendered to generate a final representation of the 3D image.

The decal application 106 can use the Gbuffer data 102, prior to subsequent renderings by the GPU 102, for calculations further described with respect to the subsequent figures. For example, the decal application program 106 may use the Gbuffer data 102 as the input to produce a proxy mesh and its respective 2D parameterization. As further described below, a 2D or 3D decal may then be projected on the screen from the proxy mesh.

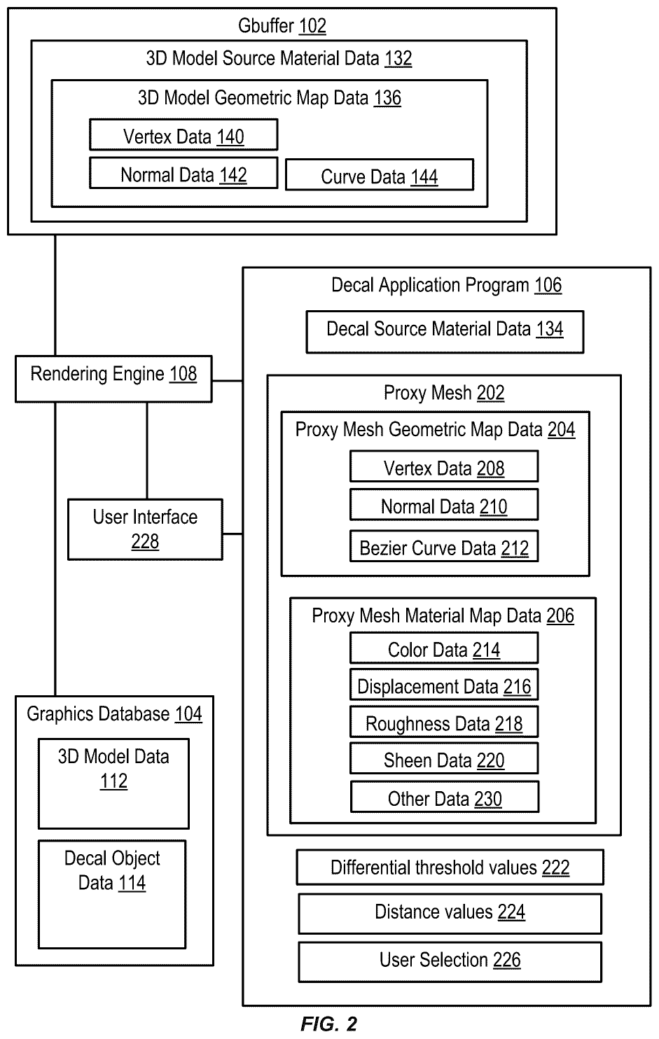

As described further in FIG. 2, the decal application program 106 may access the Gbuffer data 102 for further data processing. The decal application program 106 can thus use partially rendered geometric data processed by the rendering engine 108 prior to the rendering engine 108 completing a full rendering of data stored in the graphics database 104 such as the 3D model data 112 and the decal object data 114.

FIG. 2 shows an example of a decal application program 106 retrieving Gbuffer data 102 as input for processing a proxy mesh according to certain embodiments of the disclosure. The decal application program 106 includes a proxy mesh 202 defined by geometric map data 204 and material map data 206, as well as additional data 222-226 for processing the proxy mesh 202.

The proxy mesh 202 includes geometric map data 204 similar to the 3D model geometric map data 135 and the decal geometric map data 138. The proxy mesh geometric map data 205 may include geometric data such as vertex data 208, normal data 210, and Bezier Curve Data 212. The proxy mesh material map data 206 may contain data similar to the 3D model material map data 152 and the decal material map data 154 such as color data 214, displacement data 216, roughness data 218, and sheen data 220.

The decal application program 106 may perform operations on the proxy mesh 202 such that the data 204 206 changes over the course of the decal application program 106 operations. For instance, in a first operation, the decal application program 106 may generate a proxy mesh 202 with non-deformed geometric map data 204. The vector data 208, normal data 210, and bezier curve data 212 may be generated with default values. The proxy mesh 202 may be generated based on a user selection 226. The user selection 226 may be provided by a user through a user interface 228. For instance, when viewing an underlying 3D model object, the user may drag and drop a rectangular box over the 3D model object as shown on the user interface 228. The boundaries of the proxy mesh 202 may then be defined by the user selection 226. After the first operation, the proxy mesh 202 may be referred to as non-deformed. Thus, the boundary of the user selection 226 may select only a portion of a surface of the 3D model source material data 304.

In a second operation, also referred to as deformation, the decal application program 106 may perform a deformation process to deform the proxy mesh geometric map data 204 to approximate the surfaces and contours of the underlying 3D model source material data 132. The decal application program 106 may retrieve 3D model source material data 132 from the Gbuffer data 102 such as the 3D model geometric map data 136 including the vertex data 140, normal data 142, and curve data 144. Then, through optimization techniques further described in subsequent figures, the decal application program 106 can map the non-deformed proxy mesh geometric map data 204 to the 3D model geometric map data 136. Proxy mesh vertex data 208 may be mapped to the 3D model vertex data 140. Similarly normal data 210 and curve data 212 may be mapped to the 3D model normal data 142 and curve data 144 respectively. Mapping the proxy mesh geometric map data 204 to the 3D model geometric map data 136 may entail calculating the closest geometries of the proxy mesh geometric map data 204 to the 3D model geometric map data 136. For instance, a distance between the Bezier curve data 212 of the proxy mesh geometric map data 204 and the curve data 144 of the 3D model geometric map data 136 may be calculated to guide the deformation of the proxy mesh and to fit the underlying 3D model data 112.

The decal application program 106 also includes differential threshold values 222 and distance values 224 that may be calculated and applied by the decal application program 106 during the deformation process. After proxy mesh geometric map 204 data is mapped to the 3D model geometric map data 136, the decal application program 106 can calculate distance values 224 between the proxy mesh geometric map data 205 and the 3D model geometric map data 136. For instance, distance values 224 may be calculated between the curve data 144 of the Gbuffer data 102 and the proxy mesh Bezier curve data 212. If a distance between a Bezier curve of the proxy mesh 202 and a mapped curve of the 3D model geometric map data 136 exceeds a differential threshold value 222, the decal application program 106 will generate additional proxy mesh 202 Bezier curves stored as the Bezier curve data 212. The newly generated Bezier curves will be defined between the mapped curvatures that exceed the differential threshold values 222. The decal application program 106 may then map the newly generated Bezier curve data 212 to the 3D model geometric map curve data 144, and again calculate distance values 224 between the newly generated proxy mesh Bezier curve data 212 and the mapped 3D model geometric map curve data 144. The deformation process may iterate until the calculated distance values 224 for each of the proxy mesh Bezier curve data 212 mapped to the 3D model curve data 144 does not exceed the differential threshold values 222.

Similar processes may be applied by the decal application program 106 using normal data 210 or vertex data 208, wherein the decal application program 106 in a first operation generates non-deformed normal data 210 and vertex data 208. The decal application program 106, in the second deformation operation, may then iteratively map and subdivide the normal data 210 or the vertex data 208 to the 3D model normal data 142 or vertex data 140 until the normal distance values or vertex distance values between the mapped normal data or mapped vertex data 208 does not exceed a differential threshold value 222.

In a third operation, the decal application program 106 may apply the decal material map data 154 to the to the deformed proxy mesh material map data 206. During the deformation process, the proxy mesh 202 may retain UV parameterization to facilitate UV mapping of the decal model material map data 154 onto the proxy mesh material map data 206 by the decal application program 106.

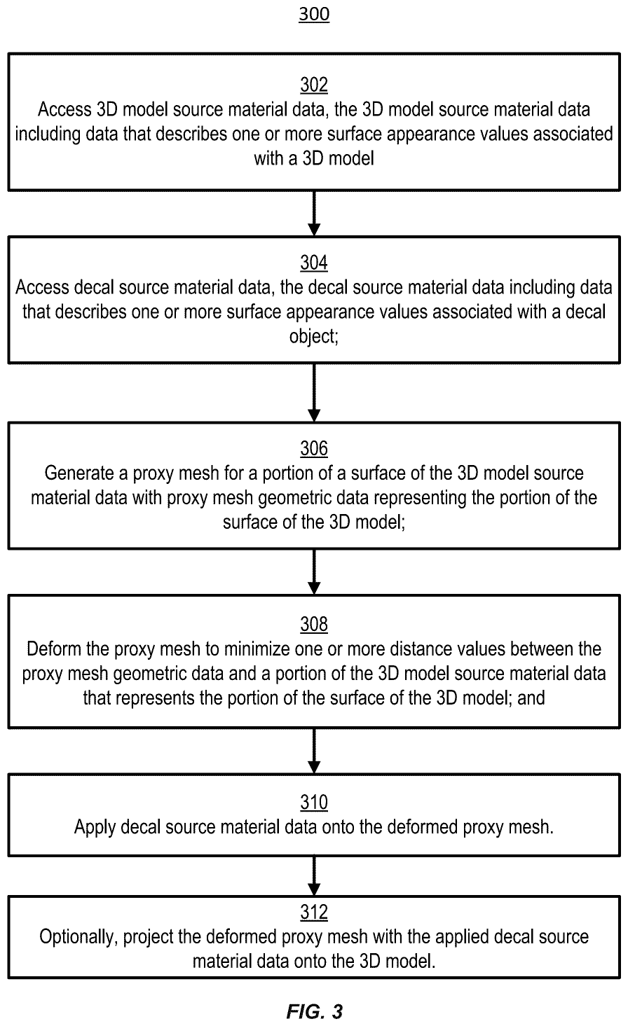

FIG. 3 show an example of a process 300 for applying textures to 3D models through use of a proxy mesh 202 implemented by a decal application program 106 according to certain embodiments of the disclosure. The process 300 depicted in FIG. 3 may be implemented in software (e.g., code, instructions, program) executed by one or more processing units of the computer system, implemented in hardware, or implemented in a combination of software and hardware. The process 300 presented in FIG. 3 and described below is intended to be illustrative and non-limiting. Although FIG. 3 depicts various processing operations occurring in a particular sequence or order, this is not intended to be limiting. In certain alternative embodiments, the processing may be performed in a different order, or some operations may also be performed in parallel.

At block 302 the decal application program 106 accesses 3D model source material data 132 of the Gbuffer data 102. The 3D model source material data 132 may have originally been the 3D model data 112 subsequently rendered by the rendering engine 108. The 3D model source material data 132 can include 3D model geometric map data 136 describing the geometry of a partially rendered 3D model from a camera point of view. The 3D model source material data may include vertex data 140, normal data 142, and curve data 144. Similarly, the 3D model source material data 132 may include 3D model material map data 152 including data describing the texture and characteristics of the underlying 3D model such as color data 156, displacement data 158, roughness data 160, sheen data 162, and any other material map data 172 including metalness, additional, normals, clear coat shading, or glints.

At block 304, the decal application program 106 performs a similar process to retrieve decal source material data 134 from the Gbuffer data 102. In one embodiment, the decal application program 106 may only retrieve the decal material map data 154 describing the color 164, displacement 166, roughness, sheen 170, and any other material map data 174 including metalness, additional, normals, clear coat shading, or glints, of the partially rendered decal object.

At block 306, the decal application program 106 generates proxy mesh 202 for a portion of a surface of the 3D model source material data 132. At this stage, the proxy mesh 202 is not deformed. The generated proxy mesh 202 includes proxy mesh geometric map data 204 representing a portion of the surface of the partially rendered 3D model geometric map data 136. The proxy mesh 202 can be generated as a 3D grid, or a 2D grid that later deforms into a 3D grid. The proxy mesh 202 may be defined by a user providing an input or user selection 226 through a user interface 228. For instance, the user may drag a rectangular box on a display device to define the proxy mesh geometry. Alternatively, the decal application program 106 may determine the dimensions of the proxy mesh based in part the dimensions of the decal source material data 134 such as the decal model geometric map 136.

The generated proxy mesh 202 may include geometric map data 204 including any number of vertices, faces, and edges as defined by the vertex data 208. These vertices, faces, and edges can be recursively defined in a grid like format, evenly distributing U and V axes of the proxy mesh 202. A higher detail or finer proxy mesh 202 will contain a larger number of vertex data 208. Lower detail proxy meshes 202 can contain fewer vertices and faces. The faces can be rectangular, triangular, or any other polygonal shape defined by vertices and edges. In a preferred embodiment, the proxy mesh 202 is subdivided into rectangular faces. At block 306, the proxy mesh 202 is yet to be deformed, and thus the proxy mesh geometric map data 204 may be coplanar.

At block 308, the decal application program 106 deforms the proxy mesh geometric map data 204 to minimize one or more distance values 224 between the proxy mesh geometric map data 204 and a portion of the 3D model geometric map data 136. Distance values 224 between the proxy mesh geometric map data 204 and the portion of the 3D model may also be referred to as the error or the energy differential between proxy mesh geometric map data 204 and the 3D source material data 132. The proxy mesh geometric map data 204 may specifically be the vertex data 208 of the proxy mesh 202, representing the geometric and position of each vertex of the proxy mesh. The 3D model geometric map data 136 may similarly be the vertex data 140 of the partially rendered 3D model. In other embodiments, the decal application program may deform the proxy mesh 2022 normal data 210 or Bezier curve data 212.

In one embodiment, the decal application program 106 deforms the proxy mesh 202 through matching the directions of the surface normals of the proxy mesh normal data 210 and the 3D model geometric map normal data 142. Once the decal application program 106 calculates the best fit matching surface normals between the proxy mesh normal data 210 and the 3D model geometric map normal data 142, the vertex data 208 of the proxy mesh 202 surrounding the surface matching proxy mesh normal data 210 is adjusted to match the direction of the underlying 3D model geometric map normal data 142 In some cases, adjusting the vertex data 208 of the proxy mesh 202 could lead to proxy mesh vertex data 208 collapsing on itself. To avoid this, the decal application program 106 can push the vertices within the vertex data 208 of the proxy mesh a set distance from each other. To push the vertices within the vertex data 208 a set distance from each other, decal application program 106 may apply optimization techniques such a Newton-type optimization methods optimization coupled with a Hessian matrix. Other optimization techniques, such as gradient descent optimization may be used to reduce the vertex distances.

During the deformation process, the decal application program 106 recursively subdivides the proxy mesh 202 into sub-grids based on the distance values between the proxy mesh 202 geometric map data 204 and the 3D model geometric map data 136. Differential threshold values 222, such as a threshold Bezier curvature values, or threshold vertex distance between the proxy mesh 202 and the 3D model may inform the decal application program 106 to subdivide the proxy mesh geometric data 202, such as the proxy mesh 202 vertex data 140 at a plane adjacent to the proxy mesh 202 Bezier curves or vertices exceeding a differential threshold value 222. For instance, as the decal application program 106 deforms the proxy mesh 202 about a specific area of the underlying 3D model source material data 132, the specific area of the underlying 3D model source material data 132 may be jagged, rough, or otherwise difficult to approximate using a single face or polygon defined by the proxy mesh 202 vertex data 208. A face or polygon of the proxy mesh 202 will have vertices or Bezier curves that fail to accurately approximate the jagged edge of the underlying 3D model geometric map data 136 defined by the 3D surface's own vertex data 140 or curve data 144. If distance values 224 at these points or curves exceeds a differential threshold value 222, the decal application program 106 will subdivide the planes of the proxy mesh 202 defined by the vertex data 208 or Bezier curve data 212 exceeding the differential threshold value 222 and then repeat distance value 224 calculations, and again compare the distance values 224 calculations with the differential threshold value 222. The differential threshold value 222 may be a specific distance between proxy mesh vertex data 208 or Bezier curves data 212 and the 3D model source material vertex data 140 or curve data 144, or alternatively may be a percentage deviation between vertices or curves. The decal application program 106 terminates the deformation process once the distance values 224 between the proxy mesh 202 and the 3D model source material data 132 data are less than the differential threshold value 222.

Subgrids of the proxy mesh 202 may thus be not of uniform shape or size. Instead, the size of the planes and subgrids of the proxy mesh 202, defined by the vertex data 208, will vary in size according to the underlying surface topology of the 3D model source material data 132. Where the topology of the 3D model source material data 132 is sharp or complex, the proxy mesh 202 will include a finer concentration of vertex data 208, and normal data 210 to match the complexity of the 3D model surface topology defined by the 3D model source material data 132.

The decal application program 106 can apply a variety of deformation techniques to minimize the distance values 224 between the proxy mesh 202 and the 3D model source material data 132. Quadric error functional minimization or other error minimization techniques may be applied to proxy mesh 202 vertex data 208 or Bezier curve data 212 to adjust the positioning of proxy mesh vertices or Bezier curves so as to distance values 224 between the proxy mesh 202 and the 3D model source material data 132.

In some embodiments, the decal application program 106 includes a machine learning model to reduce the distance values between the proxy mesh 202 and the 3D model source material data 132. Training the machine learning model can include providing the decal application program 106 with a set of training data representing 3D model source material data 132 with various representations and surface complexities. For instance, the training data set can comprise objects of relatively flat or smooth curvatures. The training set can also comprise objects of progressively more jagged topologies requiring greater recursive subdivision of the proxy mesh 202. Training sets may also include partially rendering 3D model data 112 e.g. point cloud data 116 or implicit surface data 118. The composition of the training data set(s) may vary depending on the type of machine learning model used. For instance, a machine learning model specific to point cloud data 116 may be trained exclusively on training data sets comprised of point cloud representations. The machine learning model can rely on a variety of machine learning architectures including convolutional neural networks (CNN), graph neural networks (GNN), or recurrent neural networks (RNN).

During the deformation process of block 308, the proxy mesh 202 retains a UV parameterization. Subdividing and deforming the proxy mesh 202 does not disturb the underlying UV representation of the proxy mesh 202. At block 310, the decal application program 106 applies the decal source material data 134 onto the deformed proxy mesh 202. Applying the decal source material data 134 onto the deformed proxy mesh 202 can include UV mapping decal source material data 134 such as the decal model material map data 154 onto the corresponding vertex data 208 of proxy mesh 202. Corresponding vertex data 208 can be defined by the UV mapping of the decal source material data 134 onto the proxy mesh 202. Applying the decal source material data 134 can include texturizing the proxy mesh 202 material map data 206 with features of the decal material map data 154 such as the decal model color data 164, displacement data 166, roughness data 168, sheen data 170, and any other material map data 174 including metalness, additional, normals, clear coat shading, or glints.

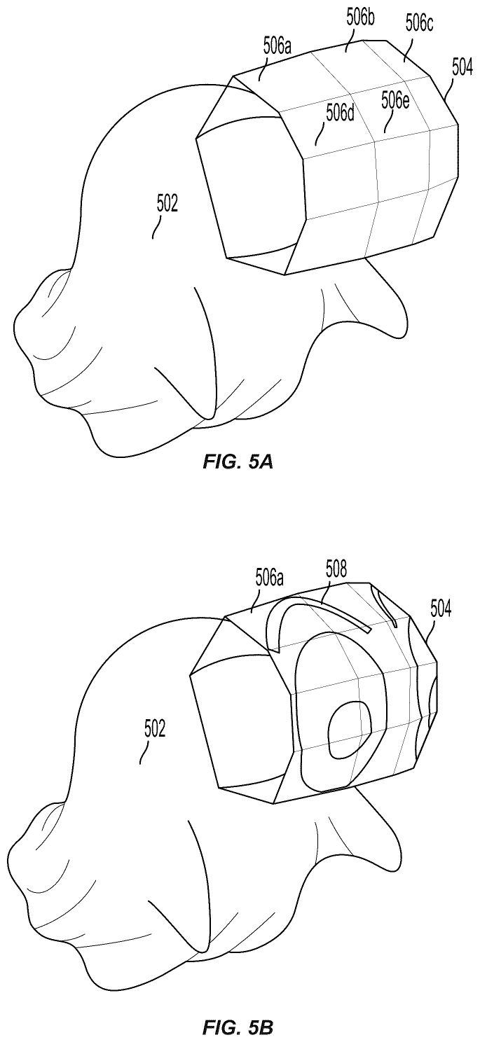

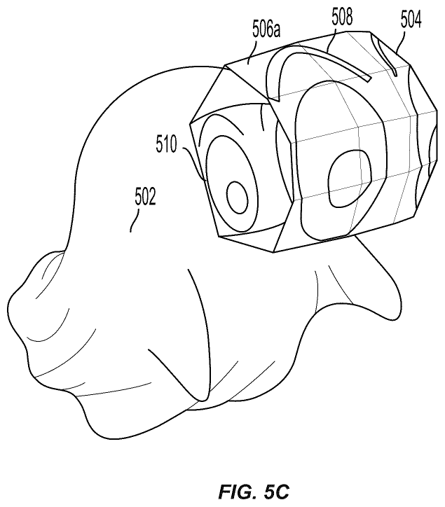

After block 310, the process 300 for applying textures to 3D models through use of a proxy mesh 202 implemented by a decal application program 106 may conclude. In other embodiments however, the process may continue to block 312. At block 312, the decal application program 106 may project the deformed proxy mesh 202 with the applied decal source material data 134 data onto the 3D model. Different projection techniques may be applied including ray tracing or volumetric sampling to cast a decal object onto the 3D model. The projection technique applied may depend on the underlying surface representation of the 3D model. Additional reference to projection techniques is discussed further with respect to FIG. 5.

The decal source material data 134 may form a 2D or 3D shape when generated by the rendering engine 108. When the decal source material data 134 represents a 2D shape, the process for applying the decal source material data 134 onto the deformed proxy mesh 202 involves mapping the 2D decal source material data 134 to the proxy mesh 202 through UV mapping procedures. When the decal object is a 3D shape, the process for applying the decal source material data 134 onto the deformed proxy mesh 202 further involves UV unwrapping the decal source material data 134 from its initial 3D shape into a 2D UV mapping. Then with the 2D UV mapping, the decal application program 106 applies UV mapping procedures to the proxy mesh 202. In such an application process, the proxy mesh 202 can retain 3D features of the decal source material data 134 when applying the decal to the deformed proxy mesh 202.

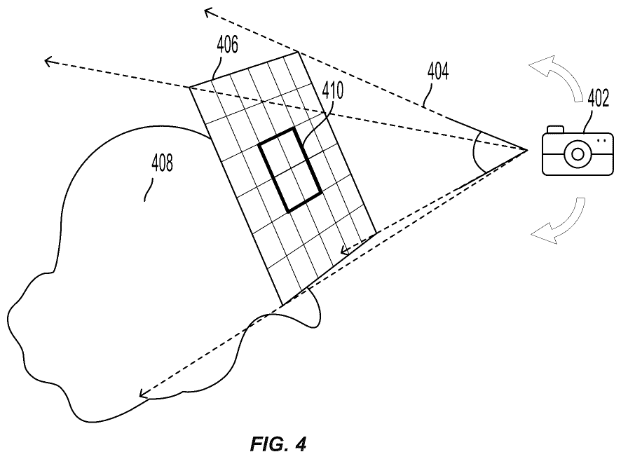

FIG. 4 shows an example of proxy mesh 202 generation according to certain embodiments of this disclosure. The embodiment of FIG. 4 includes a camera 402, with a field of view 404 and a grid interface 406 for selecting a proxy mesh 410 of a 3D model 408 for which a proxy mesh 202 will be generated. Camera 402 is a non-physical abstract representation, shown for illustrative purposes only, of the point view of a user interface 228 which is movable relative to the 3D model 408 of fixed coordinates. The field of view 404 as seen by the camera 402 is rendered by the rendering engine 108. The 3D model 408 may have fixed coordinates in the rendering environment, as defined by 3D model data 112. The specific view of the 3D model 408, from the field of view 404 of the camera 402, may be generated by the rendering engine 108. The rendering engine 108 calculates the visual representation of the 3D model 408 from the perspective of the camera 402 and recalculates the visual representation of the 3D model 408 at each frame when the camera 402 is moved. Camera 402, representing the field of view 404 in a graphical display, may be moved relative to the fixed coordinate system. For instance, a user using a user interface 228 may scroll or drag a graphical display within the user interface 228 around the 3D model 408. Moving the graphical display is synonymous with moving the camera 402 and the camera field of view 404. When camera 402 moves, the rendering engine 108 updates the Gbuffer data 102 by reprocessing data stored in the graphics database 104 relative to the camera 402 field of view 404.

The camera 402 field of view 404 is shown including a grid interface 406 normal to the camera's field of view 404. A user may optionally select the grid interface 406 for user display or may deselect the grid interface 406 so that it is not shown. When the grid interface 406 is displayed, a user may define a sub portion of the grid interface 406 as a proxy mesh selection 410 for generating a proxy mesh 202. For instance, a user may drag a rectangular box on the grid interface 406 that overlays a portion of an underlying 3D model 408. The proxy mesh selection 410 shown in FIG. 4 rectangular shape, though the proxy mesh selection 410 can have an arbitrary shape. In other embodiments, the user may drag their mouse in a freeform such that the proxy mesh selection 410 is any defined closed shape.

In other embodiments, the size and geometry of the proxy mesh selection 410 is defined by the geometric data of the decal object. When the proxy mesh selection 410 is defined by the decal model geometric map data 136, the grid interface 406 need not be shown. Once the proxy mesh selection 410 boundaries are defined, either by the user manually providing the selection, or based on the dimensions of the decal model geometric map data 136, the proxy mesh 202 is generated.

FIGS. 5A-5C show an example of a deformed proxy mesh 504 having a decal object 508 applied to the proxy mesh 504 and then projected 510 onto the underlying surface of a 3D model 502. The examples of FIGS. 5A-5C may coincide with the examples discussed with respect to blocks 308 and 310 of FIG. 3.

FIG. 5A shows the proxy mesh 202, after it is deformed to fit the surface of the underlying 3D model 408. The deformed proxy mesh 504 comprises sub grids including planes 506a-e. Planes such as 506a-e may comprise any polygonal shape. Planes including 506 have at least three vertices. The planes 506a-e and the vertices may be stored as the proxy mesh geometric map data 204. In the example of FIG. 5A, the deformed proxy mesh 504 is shown comprising rectangular planes 506a-e. In other embodiments the planes may be triangular in shape. The decal application program 106 may recursively subdivide the planes 506 into smaller planes depending on the shape of the underlying surface of the 3D model 502. By subdividing the deformed proxy mesh 504 into a finer collection of planes 506, the decal application program 106 may reposition the subdivided planes closer to the underlying 3D model surface to minimize the distance values 224 between plane 506 vertices and the underlying 3D model surface. The decal application program 106 can continue until the distance values 224 are under the differential threshold value 222.

FIG. 5B shows the deformed proxy mesh 504 after the decal application program 106 has applied the decal object 508 to the deformed proxy mesh 504. The decal object 508 may include the decal source material data 134 such as the decal model material map data 154 or the decal model geometric map data 136. During the deformation process discussed above, the deformed proxy mesh 504 retains a UV parameterization comprising planes 506a-e. The decal application program 106 retrieves the decal source material data 134 from the Gbuffer data 102 and maps the decal source material data 134 onto the deformed proxy mesh 504. The deformed proxy mesh 504's UV mapping allows for a linear transformation of the decal source material data 134 onto the deformed proxy mesh 504.

FIG. 5C shows additional operations that the decal application program 106 may perform including projecting the deformed proxy mesh 504 with the decal image 508 onto the 3D model 502. The projecting operation represented in FIG. 5C may allow for visual representation of the decal object 508 onto the 3D model 502 without occluding the space between the 3D model 502 and the deformed proxy mesh with the applied decal object 510. Different projection techniques may be applied including ray tracing to cast a decal object onto the 3D model 502. For instance, the projection technique applied may depend on the underlying surface representation of the 3D model. If the 3D model representation includes point cloud data 116, a different projection technique may be applied compared to projection of the deformed proxy mesh 504 onto an implicit surface data 118 representation of the 3D model. Projection techniques may include ray tracing performed from the perspective of the camera. Alternatively, ray tracing may be performed by projecting rays to or from the camera to map the deformed proxy mesh onto the underlying 3D model. Other projection techniques such as volumetric sampling may be applied depending on the underlying surface representation of the 3D model.

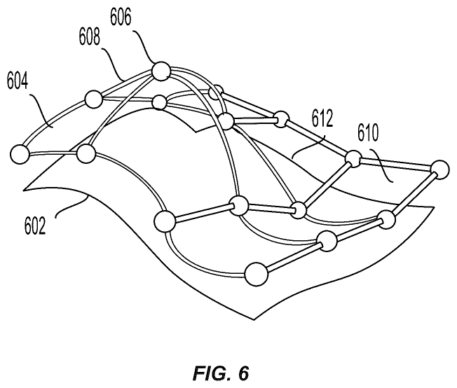

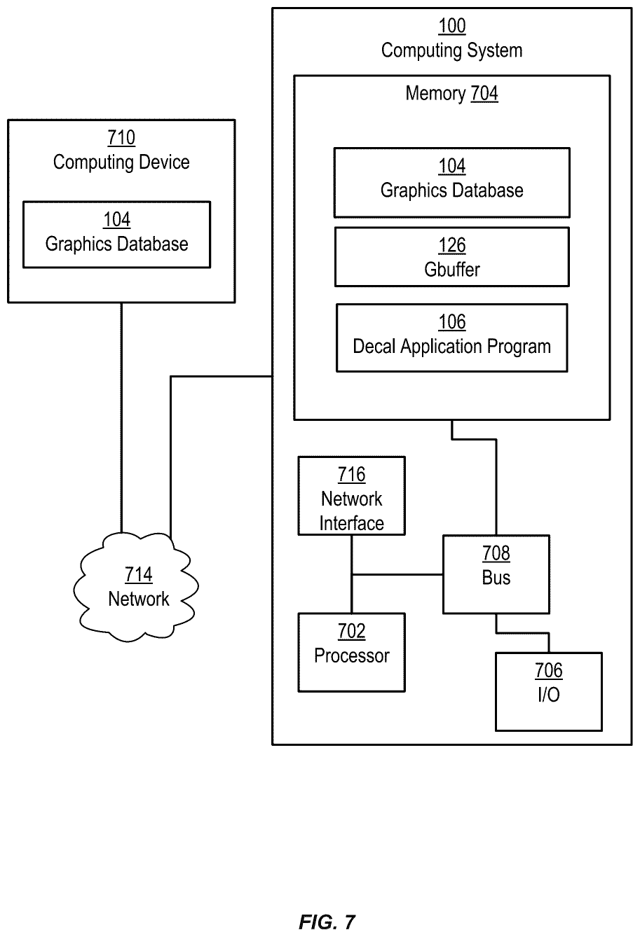

FIG. 6 shows examples of proxy mesh 604 geometric data displayed as geometric patches in the form of vertices 606, Bezier curves 608 and curved planes 610 deformed to approximate an underlying surface 602. The proxy mesh 604 geometric data 606-610 may be the proxy mesh geometric map data 204 as described in FIG. 2. The underlying surface 602 may be the 3D model geometric map data 136 as described in FIG. 1. Distances between a proxy mesh vertex 606, Bezier curve 608, or curved plane 610 and the underlying surface 602 may define the respective distance values 224 for the proxy mesh 604. The decal application program 106 may subdivide one or more planes 610 by adding Bezier curves 608 and/or vertices 606 dividing the curved planes 610 to reduce the distance values 224 between the proxy mesh 604 geometric data and the 3D model source material data 132 such as the vertex data 208 or Bezier curve data 212. For instance, if a vertex 606 or Bezier curve distance value 224 exceeds a differential threshold value 222, the decal application program 106 will subdivide the corresponding plane by adding additional Bezier curves 608 and/or vertices 606 to the proxy mesh 604. The Bezier curves 608 and vertices 606 will be repositioned to minimize their distance to the underlying surface 602, and the distance values 224 again compared to the differential threshold value 222. It is to be appreciated that the above described techniques of deforming the proxy mesh to match an underlying surface 602 can be applied to proxy meshes comprising a variety of planes 610 or polygonal faces. For instance, the Bezier curves 608 may form three vertex corners 604 and form triangular curved planes 610. FIG. 7 shows an example of a computing system 100 that performs certain operations described herein, according to certain embodiments of the present disclosure. Any suitable computing system or group of computing systems can be used for performing the operations described herein. For example, FIG. 7 depicts an example of computing system 100 that executes a decal application program 106. In some embodiments a separate computing system having devices similar to those depicted in FIG. 7 (e.g., a processor, a memory, etc.) executes certain other aspects of the decal application program 106.

The depicted example of a computing system 100 includes a processor 702 communicatively coupled to one or more memory devices 704. For instance, the graphics database 104 and Gbuffer data 102 may be stored as memory devices 704. The processor 702 executes computer-executable program code stored in a memory device 704, accesses information stored in the memory device 704, or both. Examples of the processor 702 include a microprocessor, an application-specific integrated circuit (ASIC), a field-programmable gate array (FPGA), or any other suitable processing device. The processor 706 can include any number of processing devices, including a single processing device.

The memory device 704 includes any suitable non-transitory computer-readable medium for storing data, program code, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C #, Visual Basic, Java, Python, Perl, JavaScript, and ActionScript.

The computing system 100 may also include a number of external or internal devices, such as input or output devices. For example, the computing system 100 is shown with one or more input/output (“I/O”) interfaces 706. An I/O interface 706 can receive input from input devices or provide output to output devices. One or more buses 708 are also included in the computing system 100. The input and output devices can include external computing devices 710 and/or graphics databases 104 connected to the computing system 100 by data network 714 and bus 708. The bus 708 communicatively couples one or more components of a respective one of the computing system 100.

The computing system 100 executes program code that configures the processor 702 to perform one or more of the operations described herein. The program code includes, for example, the decal application program 106 and an associated rendering engine 108, Gbuffer 102 etc. The program code may be resident in the memory device 704 or any suitable computer-readable medium and may be executed by the processor 702 or any other suitable processor. In some embodiments, the decal application program 106 is stored in the memory device 704, as depicted in FIG. 7. In additional or alternative embodiments, certain other aspects of decal application program 106 are stored in different memory devices of different computing systems 100 and computing devices 710. In additional or alternative embodiments, the program code described above is stored in one or more other memory devices accessible via a data network 714.

The computing system 100 can access the graphics database 104 in any suitable manner. In some embodiments, the graphics database 104 is stored in the memory device 704. In other instances, the graphics database 104 is stored remotely in another computing device 710 and is accessible by the computing system 100 via a data network 714.

The computing system 100 also includes a network interface device 716. The network interface device 716 includes any device or group of devices suitable for establishing a wired or wireless data connection to one or more data networks, such as data network 714. Non-limiting examples of the network interface device 716 include an Ethernet network adapter, a modem, and the like. The computing system 100 is able to communicate with one or more other computing devices (e.g., a computing device) executing other aspects of the decal application program 106 or hosting portions of the graphics database 104 via a data network using the network interface device 716.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied-for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method for applying decal information to a three dimensional (“3D”) model comprising:
accessing 3D model source material data, the 3D model source material data including data that describes one or more surface appearance values associated with a 3D model;
accessing decal source material data, the decal source material data including data that describes one or more surface appearance values associated with a decal object;
generating a proxy mesh for a portion of a surface of the 3D model source material data with proxy mesh geometric data representing the portion of the surface of the 3D model;
deforming the proxy mesh to minimize one or more distance values between the proxy mesh geometric data and a portion of the 3D model source material data that represents the portion of the surface of the 3D model; and
applying decal source material data onto the deformed proxy mesh.

2. The method of claim 1 further comprising projecting the deformed proxy mesh with the applied decal source material data onto the 3D model.

3. The method of claim 1 wherein the proxy mesh geometric data includes vertex data and a subset of the one or more distance values includes vertex distance values, wherein deforming the proxy mesh geometric data includes deforming the vertex data by applying quadric error functional minimization to minimize the vertex distance values between the deformed proxy mesh vertex data and the portion of the 3D model source material data.

4. The method of claim 3 wherein the proxy mesh geometric data includes Bezier curve data and a subset of the one or more distance values includes Bezier curve distance values, wherein deforming the proxy mesh geometric data includes deforming the Bezier curve distance values between the deformed proxy mesh Bezier curve data and the portion of the 3D model source material data.

5. The method of claim 4 wherein a region of the proxy mesh is recursively subdivided to generate additional vertex data and Bezier curve data while a Bezier curve distance value of one of the Bezier curves within the region exceeds a curvature threshold value.

6. The method of claim 1 wherein the 3D model source material data includes a surface normal map accessed from a Gbuffer.

7. The method of claim 1 wherein the 3D model comprises a point cloud or an implicit surface.

8. The method of claim 1 wherein the proxy mesh has a UV parameterization and the 3D model lacks a UV parameterization.

9. The method of claim 1 wherein the 3D model source material data and the decal source material data includes information related to surface depth, surface normal, or surface color.

10. A system comprising:
a memory component;
a processing device coupled to medium storing executable instructions which when executed by a processing device, cause the processing device to perform operations comprising:
accessing 3D model source material data, the 3D model source material data including data that describes one or more surface appearance values associated with a 3D model;
accessing decal source material data, the decal source material data including data that describes one or more surface appearance values associated with a decal object;
generating a proxy mesh for a portion of a surface of the 3D model source material data with proxy mesh geometric data representing the portion of the surface of the 3D model;
deforming the proxy mesh to minimize one or more distance values between the proxy mesh geometric data and a portion of the 3D model source material data that represents the portion of the surface of the 3D model; and
applying decal source material data onto the deformed proxy mesh.

11. The system of claim 10 wherein the processing device is further caused to perform operations comprising projecting the deformed proxy mesh with the applied decal source material data onto the 3D model.

12. The system of claim 10 wherein the proxy mesh geometric data includes vertex data and a subset of the one or more distance values includes vertex distance values, wherein deforming the proxy mesh geometric data includes deforming the vertex data by applying quadric error functional minimization to minimize the vertex distance values between the deformed proxy mesh vertex data and the portion of the 3D model source material data.

13. The system of claim 12 wherein the proxy mesh geometric data includes Bezier curve data and a subset of the one or more distance values includes Bezier curve distance values, wherein deforming the proxy mesh geometric data includes deforming the Bezier curve distance values between the deformed proxy mesh Bezier curve data and the portion of the 3D model source material data.

14. The system of claim 13 wherein a region of the proxy mesh is recursively subdivided to generate additional vertex data and Bezier curve data while a Bezier curve distance value of one of the Bezier curves within the region exceeds a curvature threshold value.

15. The system of claim 10 wherein the 3D model source material data includes a surface normal map accessed from a Gbuffer.

16. The system of claim 10 wherein the 3D model comprises a point cloud or an implicit surface.

17. The system of claim 10 wherein the proxy mesh has a UV parameterization and the 3D model lacks a UV parameterization.

18. The system of claim 10 wherein the 3D model source material data and the decal source material data includes information related to surface depth, surface normal, or surface color.

19. A non-transitory computer readable medium storing executable instructions, which when executed by a processing device, cause the processing device to perform operations comprising:
accessing 3D model source material data, the 3D model source material data including data that describes one or more surface appearance values associated with a 3D model;
accessing decal source material data, the decal source material data including data that describes one or more surface appearance values associated with a decal object;
generating a proxy mesh for a portion of a surface of the 3D model source material data with proxy mesh geometric data representing the portion of the surface of the 3D model;
deforming the proxy mesh to minimize one or more distance values between the proxy mesh geometric data and a portion of the 3D model source material data that represents the portion of the surface of the 3D model; and
applying decal source material data onto the deformed proxy mesh.

20. The non-transitory computer readable medium of claim 19 wherein the processing device is further caused to perform operations comprising projecting the deformed proxy mesh with the applied decal source material data onto the 3D model.
